(19) United States
(12) Patent Application Publication
(10) Pub. No.: US 2026/0211357 A1
(43) Pub. Date: Jul. 23, 2026

(54) IMAGE FORMING APPARATUS

(71) Applicant: CANON KABUSHIKI KAISHA, Tokyo (JP)

(72) Inventor: KENTARO YAMANA, Chiba (JP)

(21) Appl. No.: 19/428,523

(22) Filed: Dec. 22, 2025

(30) Foreign Application Priority Data
Jan. 22, 2025 (JP) 2025-009505

(51) Int. Cl. G03G 15/16; A46B 13/02; A46B 15/00; G03G 15/00; G03G 15/01

(52) U.S. Cl. CPC G03G 15/161; A46B 13/02; A46B 15/0006; G03G 15/50; A46B 2200/3073; G03G 15/0131; G03G 15/0189; G03G 2215/1661

(57) ABSTRACT

An image forming apparatus includes an intermediary transfer belt, a brush in contact with the intermediary transfer belt at a cleaning portion and a controller. The controller controls so as to execute an image forming operation in which the toner formed on the intermediary transfer belt is transferred to a recording material and an adjusting operation in which an adjustment toner image is formed on the intermediary transfer belt. The controller controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner is removed from the intermediary transfer belt by the brush.

### BACKGROUND

### Field of the Technology

The present invention relates to an image forming apparatus such as a copying machine, a printer, a facsimile device using an electrophotographic type or an electrostatic recording type, or a multifunction machine provided with a plurality of functions of these functions.

### Description of the Related Art

Conventionally, for example, some image forming apparatuses such as a printer and a copying machine using an electrophotographic type employ an intermediary transfer type. The image forming apparatus of the intermediary transfer type forms a toner image on an image bearing member such as a photosensitive drum, primarily transfers this toner image from the image bearing member onto an intermediary transfer member at a primary transfer portion, and then secondarily transfers the toner image from the intermediary transfer member onto a recording material such as a paper at a secondary transfer portion. As the intermediary transfer member, an intermediary transfer belt constituted by an endless belt is often used.

Toner remaining on the intermediary transfer belt without being transferred to the recording material in the secondary transfer portion (transfer residual toner) is removed from the intermediary transfer belt by a cleaning means at a cleaning portion and is collected. As a method for cleaning the intermediary transfer belt, there is an electrostatic cleaning type. The electrostatic cleaning type is a type which cleans the intermediary transfer belt by applying a voltage to a cleaning member having electroconductivity disposed so as to be in contact with the intermediary transfer belt, and causing the toner to be electrostatically attracted to the cleaning member from the intermediary transfer belt. As the cleaning member, an electroconductive fur brush (electroconductive fur brush roller), which is rotated with being in contact with the intermediary transfer belt, is often used (electrostatic fur cleaning type).

In Japanese Patent No. 5153431, a configuration in which a voltage applied to the fur brush and a number of rotations of the fur brush are controlled in accordance with a detection result of a current flowing through the fur brush is proposed.

By the way, in the image forming apparatus of the intermediary transfer type, an adjustment toner image (patch pattern) is formed on the intermediary transfer belt, and by detecting the patch pattern on the intermediary transfer belt with a sensor, image density control, color misregistration correcting control, etc. are performed. And, the image forming apparatus may have a configuration in which the patch pattern passes through the secondary transfer portion. In this case, the patch pattern which has passed through the secondary transfer portion is to be removed from the intermediary transfer belt at the cleaning portion.

Since the patch pattern is not transferred to the recording material, a toner density (toner amount per unit area) thereof is larger than that of the transfer residual toner. Therefore, in order to properly remove the patch pattern from the intermediary transfer belt with the electrostatic fur cleaning type, a relatively large number of rotations is required for the fur brush. When the number of rotations of the fur brush is insufficient upon removing the patch pattern from the intermediary transfer belt, due to cleaning defect occurring, defect such that the toner for the patch pattern is adhered to a subsequent print image may occur. However, by setting the number of rotations of the fur brush so as to be suitable for removing the patch pattern from the intermediary transfer belt, a number of times for which the fur brush and the intermediary transfer belt are rubbed against each other increases, so that it may cause a lifetime of parts including the intermediary transfer belt and the fur brush, etc. to be shortened.

### SUMMARY

Therefore, an object of the present invention is, while enabling to properly remove an adjustment toner image from the intermediary transfer belt, to achieve a longer life of an intermediary transfer belt and a cleaning member.

The object described above is achieved by an image forming apparatus according to the present invention. In summary, the present invention provides the following:

(1) An image forming apparatus comprising: a rotatable image bearing member configured to bear a toner image; an exposing device configured to expose the image bearing member and to form an electrostatic image on the image bearing member; a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt; a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating; a driving portion configured to drive the brush; and a controller configured to control the driving portion, wherein the controller controls so as to execute an image forming operation in which the toner formed on the intermediary transfer belt is transferred to the recording material and an adjusting operation in which an adjustment toner image is formed on the intermediary transfer belt, and controls the driving portion in the image forming operation so that the brush is rotated at a first peripheral speed Vr when a transfer residual toner remaining on the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and wherein in a case in which the adjusting operation is executed during a continuous image forming job in which image formation is continuously executed to a plurality of recording materials including a first recording material and a second recording material succeeding the first recording material, after the image formation is executed to the first recording material and before the image formation is executed to the second recording material, the controller controls the driving portion so as to change the speed of the brush from the first peripheral speed Vr to the second peripheral speed Vp after the first recording material has passed through the second transfer portion and before formation of an electrostatic image of the adjustment toner image is started.

(2) An image forming apparatus comprising: a rotatable image bearing member configured to bear a toner image; an exposing device configured to expose the image bearing member and to form an electrostatic image on the image bearing member; a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt; a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating; a driving portion configured to drive the brush; and a controller configured to control the driving portion, wherein the controller controls so as to execute an image forming operation in which the toner formed on the intermediary transfer belt is transferred to the recording material and an adjusting operation in which an adjustment toner image is formed on the intermediary transfer belt, and controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and wherein in a case in which the adjusting operation is executed during a continuous image forming job in which image formation is continuously executed to a plurality of recording materials including a first recording material and a second recording material succeeding the first recording material, after the image formation is executed to the first recording material and before the image formation is executed to the second recording material, the controller controls the driving portion so as to change the speed of the brush from the second peripheral speed Vp to the first peripheral speed Vr at a timing after a rearmost of the adjustment toner image, formed in the adjusting operation in a moving direction of a surface of the intermediary transfer belt, has reached the cleaning portion and before formation of an electrostatic image for the second recording material is started.

(3) An image forming apparatus comprising: a rotatable image bearing member configured to bear a toner image; an exposing device configured to expose the image bearing member and to form an electrostatic image on the image bearing member; a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt; a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating; a driving portion configured to drive the brush; and a controller configured to control the driving portion, wherein the controller controls so as to execute an image forming operation in which the toner formed on the intermediary transfer belt is transferred to the recording material and an adjusting operation in which an adjustment toner image is formed on the intermediary transfer belt, and controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and wherein in a case in which the adjusting operation is executed with an image formation start signal before the image forming operation is executed to the recording material for a first sheet of a job, the controller controls the driving portion so as to change the speed of the brush from the first peripheral speed Vr to the second peripheral speed Vp before formation of an electrostatic image of the adjustment toner image is started.

(4) An image forming apparatus comprising: a rotatable image bearing member configured to bear a toner image; an exposing device configured to expose the image bearing member and to form an electrostatic image on the image bearing member; a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt; a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating; a driving portion configured to drive the brush; and a controller configured to control the driving portion, wherein the controller controls so as to execute an image forming operation in which the toner formed on the intermediary transfer belt is transferred to the recording material and an adjusting operation in which an adjustment toner image is formed on the intermediary transfer belt, and controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and wherein in a case in which the adjusting operation is executed with an image formation start signal before the image forming operation is executed to the recording material for a first sheet of a job, the controller controls the driving portion so as to change the speed of the brush from the second peripheral speed Vp to the first peripheral speed Vr after the adjusting operation is executed and before formation of an electrostatic image for the recording material for the first sheet of the job.

Further features of the present invention will become apparent from the following description of exemplary embodiments with reference to the attached drawings.

### BRIEF DESCRIPTION OF THE DRAWINGS

FIG. 1 is a cross-sectional outline view of an image forming apparatus.

FIG. 2, part (a) and part (b), includes schematic views of patch patterns.

FIG. 3 is a block diagram illustrating an outline of a control configuration of the image forming apparatus.

FIG. 4 is a schematic cross-sectional view of a secondary transfer portion during image formation.

FIG. 5 is a schematic cross-sectional view illustrating a first mode of the secondary transfer portion during image correcting operation.

FIG. 6 is a schematic cross-sectional view illustrating a second mode of the secondary transfer portion during image correcting operation.

FIG. 7 is a schematic cross-sectional view of a belt cleaning device during image formation.

FIG. 8 is a schematic cross-sectional view of the belt cleaning device during image correcting operation.

FIG. 9 is a flowchart diagram for describing control for a cleaning driving portion along with the image correcting operation before an image forming operation.

FIG. 10 is a flowchart diagram for describing control for the cleaning driving portion along with the image correcting operation performed in a middle of a continuous printing.

### DESCRIPTION OF THE EMBODIMENTS

Hereinafter, an image forming apparatus according to the present invention will be described in more detail with reference to the drawings.

### EMBODIMENT 1

### Image forming apparatus

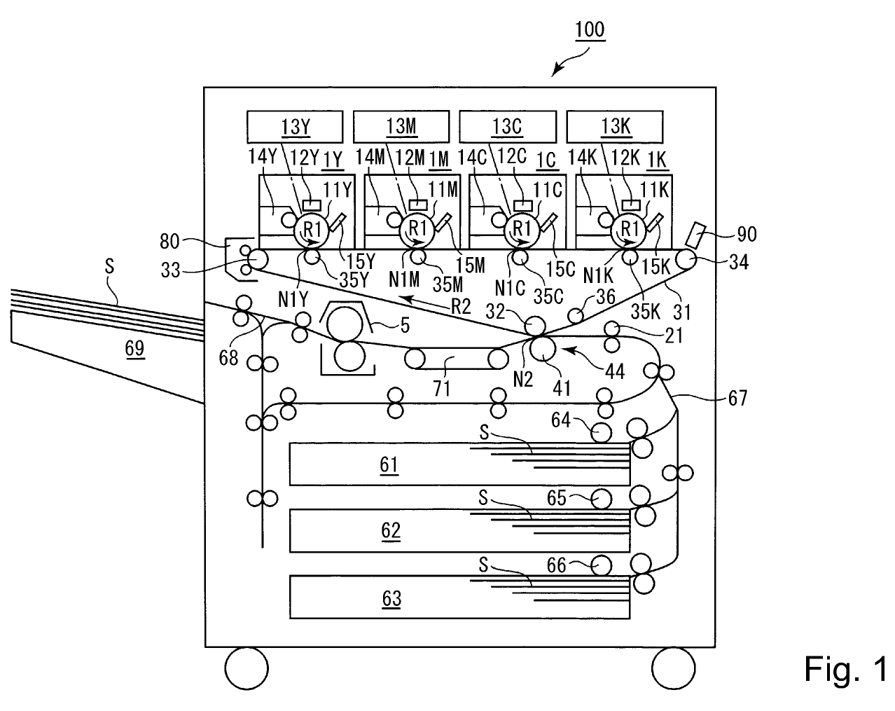

FIG. 1 is a cross-sectional outline view of an image forming apparatus 100 in the present Embodiment. The image forming apparatus 100 in the present Embodiment is a printer of a tandem type employing an intermediary transfer type, which is capable of forming a full-color image using an electrophotographic type. The image forming apparatus 100 can form, in accordance with an image signal transmitted from an external device such as a host computer, the full-color image on a recording material S having a sheet shape.

The image forming apparatus 100 includes, as a plurality of image forming portions, four image forming portions (stations) 1Y, 1M, 1C and 1K, which form toner images of yellow (Y), magenta (M), cyan (C) and black (K), respectively. The four image forming portions 1Y, 1M, 1C and 1K are disposed in line along an image transfer surface of the intermediary transfer belt 31 which extends approximately horizontally. Elements having the same or corresponding functions or configurations, which are provided for each color, may be described collectively by omitting Y, M, C and K at the ends of reference numerals, which indicate that the element is for either one of the colors. The image forming portion 1 (1Y, 1M, 1C, 1K) is configured to include a photosensitive drum 11 (11Y, 11M, 11C, 11K), a charger 12 (12Y, 12M, 12C, 12K), an exposing device 13 (13Y, 13M, 13C, 13K), a developing device 14 (14Y, 14M, 14C, 14K), a drum cleaning device 15 (15Y, 15M, 15C, 15K), etc.

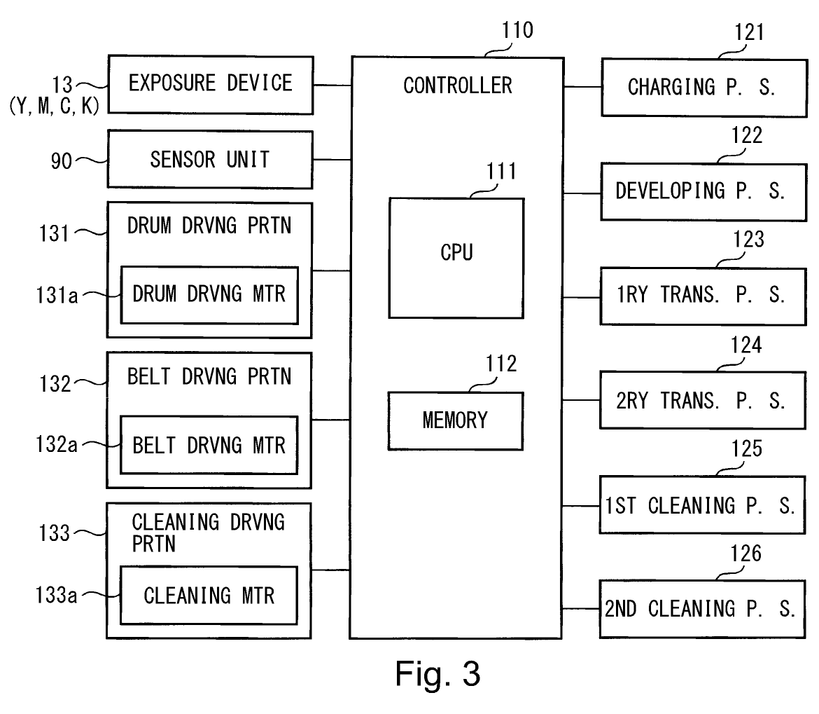

The photosensitive drum 11, which is a rotatable photosensitive member (electrophotographic photosensitive member) having a drum shape (cylindrical shape), as an image bearing member is rotationally driven in a direction of an arrow R1 (counterclockwise direction) in FIG. 1. The photosensitive drum 11 is rotationally driven by driving force being transmitted from a drum driving motor 131a of a drum driving portion 131 (FIG. 3) as a photosensitive member driving means thereto. A surface of the rotating photosensitive drum 11 is uniformly charged, by the charger 12 as a charging means, to a predetermined potential of predetermined polarity (negative polarity in the present Embodiment). During charging, to the charger 12, by a charging power source (high voltage power source) 121 (FIG. 3) as a charging voltage applying portion, a charging bias (charging voltage) is applied. The surface of the charged photosensitive drum 11 is scanned and exposed, by the exposing device 13 as an exposing means, by being irradiated with a laser light in accordance with the image signal (image information), and an electrostatic latent image (electrostatic image) corresponding to the image signal is formed on the surface of the photosensitive drum 11. In the present Embodiment, the exposing device 13 is configured to include a laser scanner. Incidentally, the exposing device 13 may be configured as one unit which exposes the photosensitive drums 11 in the plurality of image forming portions 1. In addition, the exposing device 13 is not limited to be configured to include the laser scanner using a laser light source as a light source, but may be configured to include an LED array using an LED as the light source, etc.

The electrostatic latent image formed on the photosensitive drum 11 is developed (visualized) by toner being supplied by the developing device 14 as a developing means, and a toner image (developer image) is formed on the photosensitive drum 11. In the present Embodiment, the developing device 14 uses, as a developer, a two-component developer provided with the toner (non-magnetic toner particle) and carrier (magnetic carrier particle). The developing device 14 includes a developing sleeve as a developer carrying member (developing member), carries the developer on the rotating developing sleeve to convey the developer to an opposing portion between the developing sleeve and the photosensitive drum 11, and supplies the toner to the photosensitive drum 11. During development, to the developing sleeve, by a developing power source (high voltage power source) 122 (FIG. 3) as a developing voltage applying portion, a developing bias (developing voltage) is applied. In the present Embodiment, to an exposed portion on the photosensitive drum 11, in which an absolute value of the potential is decreased by being exposed after having been uniformly charged, the developing device 14 causes the toner charged to the same polarity as the charge polarity of the photosensitive drum 11 (negative polarity in the present Embodiment) to be adhered (reverse development type). In the present Embodiment, normal charge polarity of the toner, which is main charge polarity of the toner during development, is negative polarity.

Opposite to the four photosensitive drums 11Y, 11M, 11C and 11K, an intermediary transfer belt 31 constituted by an endless belt as an intermediary transfer member is disposed. The intermediary transfer belt 31 is hooked over a driving roller 33, a tension roller 34, a pre secondary transfer roller 36 and a secondary transfer inner roller 32 as a plurality of stretching rollers, and is stretched by predetermined tensile force. On an inner peripheral surface side of the intermediary transfer belt 31, at positions opposite to the photosensitive drums 11Y, 11M, 11C and 11K via the intermediary transfer belt 31, primary transfer rollers 35Y, 35M, 35C and 35K, which are primary transfer members having a roller shape, as primary transfer means are disposed. The primary transfer roller 35 is pressed toward the photosensitive drum 11, and forms a primary transfer portion (primary transfer nip) N1 (N1Y, N1M, N1C, N1K), which is a contacting portion (contacting position) between the photosensitive drum 11 and the intermediary transfer belt 31. The intermediary transfer belt 31 is rotated (circulately moved), by the driving roller 33 being rotationally driven, in a direction of an arrow R2 (clockwise direction) in FIG. 1. The driving roller 33 is rotationally driven by driving force being transmitted from a belt driving motor 132a of a belt driving portion 132 (FIG. 3) as an intermediary transfer member driving means thereto. The tension roller 34 applies a predetermined tensile force (tension) to the intermediary transfer belt 31. The pre secondary transfer roller 36 forms a surface of the intermediary transfer belt 31 entering a secondary transfer portion N2, which will be described below. The secondary transfer inner roller 32 forms the secondary transfer portion N2 together with a secondary transfer outer roller 41, which will be described below. The stretching rollers other than the driving roller 33 and the respective primary transfer rollers 35 are rotated driven by the rotation of the intermediary transfer belt 31.

Incidentally, in the present Embodiment, the intermediary transfer belt 31 is constituted by a belt having a three-layer structure including a base layer, an elastic layer and a surface layer in this order from the inner peripheral surface (back surface) side to an outer peripheral surface (front surface) side. As material composing the base layer, material in which an appropriate amount of carbon black as an antistatic agent is contained in resin such as polyimide (PI) and polycarbonate (PC), various types of rubber, or the like is suitably used. As elastic material composing the elastic layer, material in which an appropriate amount of ionic electroconductive agent is contained in various types of rubber such as urethane rubber and silicone rubber is suitably used. As material composing the surface layer, resin such as fluorine resin is suitably used. In the present Embodiment, as the intermediary transfer belt 31, the belt having the elastic layer is used, however, for example, a PI single layer belt in which the elastic layer is not provided, or a PI coated belt in which fluorine resin, etc. is coated on a base layer of PI may be used.

The toner image formed on the photosensitive drum 11 is transferred (primarily transferred), in the primary transfer portion N1, by an action of the primary transfer roller 35, onto the rotating intermediary transfer belt 31. During primary transfer, to the primary transfer roller 35, by a primary transfer power source (high voltage power source) 123 (FIG. 3) as a primary transfer voltage applying portion, a primary transfer bias (primary transfer voltage), which is a direct current voltage having an opposite polarity to the normal charge polarity of the toner (positive polarity in the present Embodiment), is applied. For example, during formation of the full-color image, the toner images of respective colors of yellow, magenta, cyan and black formed on the respective photosensitive drums 11 are transferred so as to be superimposed on the same image forming area on the intermediary transfer belt 31. The toner remaining on the photosensitive drum 11 without being transferred onto the intermediary transfer belt 31 (primary transfer residual toner) is removed from the photosensitive drum 11 by the drum cleaning device 15 as a photosensitive member cleaning means, and is collected.

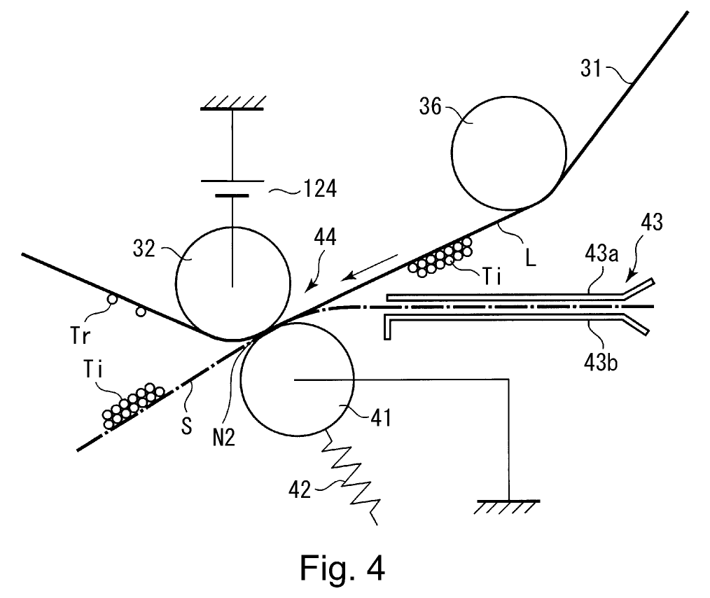

On the outer peripheral surface side of the intermediary transfer belt 31, at a position opposite to the secondary transfer inner roller 32 via the intermediary transfer belt 31, the secondary transfer outer roller 41 is disposed. The secondary transfer outer roller 41 is pressed toward the secondary transfer inner roller 32, and forms the secondary transfer portion (secondary transfer nip) N2, which is a contacting portion between the intermediary transfer belt 31 and the secondary transfer outer roller 41. The toner image formed on the intermediary transfer belt 31 is transferred (secondarily transferred), in the secondary transfer portion N2, onto the recording material S which is nipped and conveyed by the intermediary transfer belt 31 and the secondary transfer outer roller 41. During secondary transfer, to the secondary transfer inner roller 32, by a secondary transfer power source (high voltage power source) 124 (FIG. 3, FIG. 4) as a secondary transfer voltage applying portion, a secondary transfer bias (secondary transfer voltage), which is a direct current voltage having the same polarity as the normal charge polarity of the toner (negative polarity in the present Embodiment), is applied.

The recording material S such as a paper and a plastic sheet is accommodated in cassettes 61, 62 and 63 as a recording material accommodating portion. The recording material S is conveyed to a feeding conveyance path 67 by any one of feeding rollers 64, 65 and 66 as a feeding member being rotated. This recording material S is conveyed, by a registration roller 21 as a conveyance member, to the secondary transfer portion N2 in synchronization with the toner image on the intermediary transfer belt 31.

The toner remaining on the intermediary transfer belt 31 without being transferred to the recording material S (secondary transfer residual toner) is removed, by a belt cleaning device 80 as an intermediary transfer member cleaning means, from the intermediary transfer belt 31, and is collected. Details of the belt cleaning device 80 will be described below.

The recording material S onto which the toner image has been transferred is conveyed, by a conveyance belt 71 as a conveyance member, to a fixing device 5 as a fixing means. The fixing device 5 fixes (melts, sticks), by heating and pressing the recording material S carrying the unfixed toner image, the toner image to a surface of the recording material S. The recording material S to which the image has been fixed is discharged (output) to a tray 69 as a discharging portion through a discharging conveyance path 68.

Incidentally, in the present Embodiment, the image forming apparatus 100 is configured so that the recording material S supplied to the secondary transfer portion N2 is conveyed from right to left in FIG. 1, however, it is not limited thereto, but may be configured so as the recording material S to be conveyed from left to right.

The image forming apparatus 100 includes a sensor unit 90 as a toner image detecting means for detecting an adjustment toner image (patch pattern) carried and conveyed on the intermediary transfer belt 31. The sensor unit 90 is disposed, in a rotational direction of the intermediary transfer belt 31, on a downstream side of the primary transfer portion N1 (downstreammost primary transfer portion N1K) and an upstream side of the secondary transfer portion N2, so as to be capable of detecting the toner image on the intermediary transfer belt 31. In the present Embodiment, the sensor unit 90 is disposed at a position opposite to the tension roller 34 via the intermediary transfer belt 31. The sensor unit 90 may be configured so as to be capable of detecting the toner image at a plurality of locations in a widthwise direction, which is approximately perpendicular to a moving direction (conveyance direction) of a surface of the intermediary transfer belt 31. The sensor unit 90 is configured to include an optical sensor of reflection type.

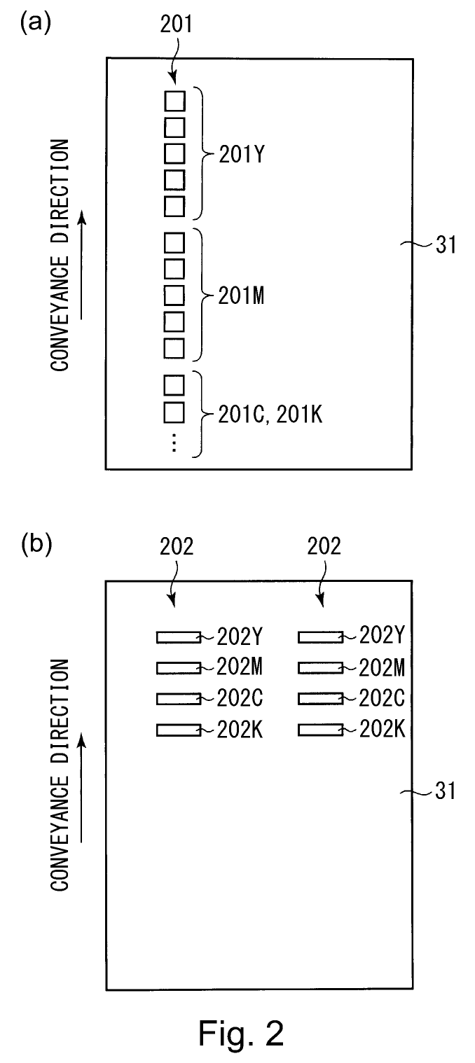

In the present Embodiment, as the patch pattern, a density patch pattern for image density control and a registration patch pattern for color misregistration (registration) correcting control are formed on the intermediary transfer belt 31, respectively. In other words, in the present Embodiment, the image forming apparatus 100 executes, as an image correcting operation (adjusting operation) in which the patch patterns are formed on the intermediary transfer belt 31, the image density control (a density correcting control) and the color misregistration correcting control. Part (a) and part (b) of FIG. 2 are schematic views illustrating an example of a density patch pattern 201 and of a registration patch pattern 202, respectively. As shown in part (a) of FIG. 2, in one image density control, as the density patch pattern 201, for each color of yellow, magenta, cyan and black, a plurality of the patch patterns having different densities are formed along the moving direction of the surface of the intermediary transfer belt 31. In addition, as shown in part (b) of FIG. 2, in one color misregistration correcting control, as the registration patch pattern 202, patch patterns of each color of yellow, magenta, cyan and black are formed along the moving direction of the surface of the intermediary transfer belt 31. The registration patch patterns 202 are formed, for example, on both end portion sides in the widthwise direction of the intermediary transfer belt 31, respectively. The patch pattern is formed, in the same manner as a print image which is transferred to the recording material S and output as a product, by being formed on the photosensitive drum 11 and transferred onto the intermediary transfer belt 31, on the intermediary transfer belt 31.

The image forming apparatus 100, for example, interrupts the image forming operation every time forming the print images on one hundred sheets of the recording material S having A4 size, and performs the formation of the density patch pattern and reading thereof with the sensor unit 90. Then, the image forming apparatus 100 resumes, after performing the image density control using the result, the image forming operation. In addition, the image forming apparatus 100 interrupts the image forming operation, in a case in which a temperature rise (ΔT) of the exposing device 13 becomes ΔT > 3 ℃, for example, and performs the formation of the registration patch pattern and reading thereof with the sensor unit 90. Then, the image forming apparatus 100 resumes, after performing the color misregistration correcting control using the result, the image forming operation.

In the present Embodiment, the patch pattern carried on the intermediary transfer belt 31 passes through the secondary transfer portion N2 without being removed from the intermediary transfer belt 31 at the secondary transfer portion N2, and is removed from the intermediary transfer belt 31 by the belt cleaning device 80. In the present Embodiment, the image forming apparatus 100 does not include a cleaning configuration, in which the patch pattern is transferred to a member (such as a roller and a belt), which is in contact with the outer peripheral surface of the intermediary transfer belt 31 and forms the secondary transfer portion N2, removed from this member, and is collected.

Incidentally, in the present Embodiment, the image forming apparatus 100 is a color image forming apparatus capable of forming a full-color image, however, the present invention is not limited thereto. The image forming apparatus may be, for example, a monochrome image forming apparatus which includes only an image forming portion for black as an image forming portion and is capable of forming a black-and-white image. In that case, since color misregistration does not occur, an operation associated with the color misregistration correcting control becomes unnecessary.

### Control configuration

FIG. 3 is a block diagram illustrating an outline of a control configuration of the image forming apparatus 100 in the present Embodiment. The image forming apparatus 100 includes a control portion (control circuit) 110 which controls the image forming apparatus 100. The control portion 110 is configured to include a CPU 111 as an arithmetic process means (arithmetic process portion), a memory (storage medium) 112 such as a ROM, a RAM and a non-volatile memory as a storage means (storage portion), an input/output portion (not shown) for performing input/output of a signal (information) between the control portion 110 and an external device, etc. The CPU 111 and the memory 112 are capable of transferring and reading of data mutually. In the ROM, control programs, data tables obtained in advance, etc. are stored. In the RAM, which is a rewritable memory, information input to the control portion 110, detected information, a calculation result, etc. are stored. In the non-volatile memory, various types of setting information, various types of history information, etc. are stored. To the control portion 110, each portion of the image forming apparatus 100 is connected. The control portion 110 is capable of controlling operations for each portion of the image forming apparatus 100 so as to cause the image forming apparatus 100 to execute various types of operations such as the image forming operation, the image density control and the color misregistration correcting control.

For example, to the control portion 110, various types of power sources including the charging power source 121, the developing power source 122, the primary transfer power source 123, the secondary transfer power source 124, a first cleaning power source 125, a second cleaning power source 126, which will be described below, etc. are connected. In addition, to the control portion 110, various types of driving portions including the drum driving portion 131, the belt driving portion 132, a cleaning driving portion 133, which will be described below, etc. are connected. In addition, to the control portion 110, the exposing device 13 (13Y, 13M, 13C, 13K), the sensor unit 90, etc. are connected. In addition, to the control portion 110, an image reading apparatus (not shown) provided in the image forming apparatus 100 or connected to the image forming apparatus 100, and/or an external device such as a host computer may be connected.

Incidentally, illustrations thereof are omitted, however, in the present Embodiment, the charging power source 121, the developing power source 122 and the primary transfer power source 123 are provided independently with respect to each image forming portion 1, respectively. In addition, the drum driving portion 131, the belt driving portion 132 and the cleaning driving portion 133 are configured to include a driving motor as a driving source, a gear as a driving transmitting member, etc., respectively. The drum driving portion 131 (or the driving motor thereof) may be provided independently with respect to each photosensitive drum 11, or may be commonized to all or a part of the photosensitive drums 11. In addition, for example, among various types of the driving portions such as the drum driving portion 131 and the belt driving portion 132, at least a part of the configurations (driving motor, etc.) may be commonized.

The image forming apparatus 100 executes a print job, which is started by one start instruction and a series of operations to form and output an image on a single or a plurality of the recording material S. The print job includes, generally, an image forming process (image forming operation), a pre rotation process (pre rotation operation), a sheet interval process (sheet interval operation) and a post rotation process (post rotation operation). The image forming process is a period in which the formation of the electrostatic latent image (exposure), the formation of the toner image (development), the primary transfer and the secondary transfer of the toner image are performed with respect to the image forming areas on the photosensitive drum 11 and the intermediary transfer belt 31, in which the print image is to be formed, and the term “during image formation” refers to this period. In more detail, timings of the “during image formation” differ at positions where the respective processes of the formation of the electrostatic latent image, the formation of the toner image, the primary transfer and the secondary transfer of the toner image are performed. The pre rotation process is a period, from when the start instruction is input until the formation of the print image is started (exposure is started), in which a preparatory operation before the image forming process is performed. The sheet interval process is a period corresponding to an interval between a recording material S and a recording material S upon performing the image formation continuously to a plurality of recording material S (continuous printing, continuous image formation). The post rotation process is a period in which an organizing operation (preparatory operation) after the image forming process is performed. The term “during non-image formation” is a period other than the “during image formation”, and includes the pre rotation process, the sheet interval process, the post rotation process, which are described above, and further includes a pre multi rotation process (pre rotation operation), which is a preparatory operation upon the image forming apparatus 100 being turned on or returning from a sleep state, etc.

### Secondary transfer portion

FIG. 4 is a schematic cross-sectional view illustrating the secondary transfer portion N2 during image formation (upon forming the print image on the intermediary transfer belt 31) (illustrating a cross section approximately perpendicular to a rotational axis direction of the secondary transfer inner roller 32.).

With a surface (pre nip stretched surface) L of the intermediary transfer belt 31 formed by being stretched by the secondary transfer inner roller 32 and the pre secondary transfer roller 36, the secondary transfer outer roller 41 is in contact. The secondary transfer outer roller 41 is pressed toward the secondary transfer inner roller 32 by a pressing spring 42 as an urging member. As a result, the secondary transfer portion N2 is formed.

During image formation (during secondary transfer of the print image), to the secondary transfer inner roller 32, by the secondary transfer power source 124, the secondary transfer bias (secondary transfer voltage) having the same polarity as the charge polarity of the toner constituting the toner image on the intermediary transfer belt 31 (normal charge polarity of the toner) is applied. The secondary transfer outer roller 41 is connected to ground (electrically grounded). As a result, a transfer electric field is formed in the secondary transfer portion N2. In the present Embodiment, since the toner constituting the toner image on the intermediary transfer belt 31 has electric charge of negative polarity (-), the voltage having negative polarity (-) is applied to the secondary transfer inner roller 32. On an upstream side of the secondary transfer portion N2 in the conveyance direction of the recording material S, a pre secondary transfer guide 43 as a recording material guiding member, which guides the recording material S toward the secondary transfer portion N2, is provided. The pre secondary transfer guide 43 is configured to include an upper guide 43a and a lower guide 43b. The upper guide 43a restricts movement of the recording material S in a direction approaching the intermediary transfer belt 31. The lower guide 43b restricts movement of the recording material S in a direction going away from the intermediary transfer belt 31. And in the secondary transfer portion N2, from the intermediary transfer belt 31, onto the recording material S guided by the pre secondary transfer guide 43 and conveyed to the secondary transfer portion N2, a toner image Ti constituting the print image is transferred (secondarily transferred). In the present Embodiment, by the secondary transfer inner roller 32 as a secondary transfer member and the secondary transfer outer roller 41 as a secondary transfer opposite member, a secondary transfer device 44 as a secondary transfer means is constituted. Incidentally, it may be configured that a secondary transfer bias having the opposite polarity to the normal charge polarity of the toner is applied to the secondary transfer outer roller 41 as the secondary transfer member, and the secondary transfer inner roller 32 as the secondary transfer opposite member is connected to the ground (electrically grounded).

On the intermediary transfer belt 31, transfer residual toner (secondary transfer residual toner) Tr remaining on the intermediary transfer belt 31 without being transferred to the recording material S in the secondary transfer portion N2 is generated. This transfer residual toner Tr is conveyed, while being carried on the intermediary transfer belt 31, to a downstream side of the secondary transfer portion N2 in the moving direction of the surface of the intermediary transfer belt 31.

In the image forming apparatus 100 in the present Embodiment, a ratio (secondary transfer efficiency), at which a solid (maximum density) toner image of a single color is transferred from the intermediary transfer belt 31 onto the recording material S in the secondary transfer portion N2, is about 97%. In other words, in the image forming apparatus 100 in the present Embodiment, about 3% of the toner in the solid toner image of the single color remains on the intermediary transfer belt 31 as the transfer residual toner Tr.

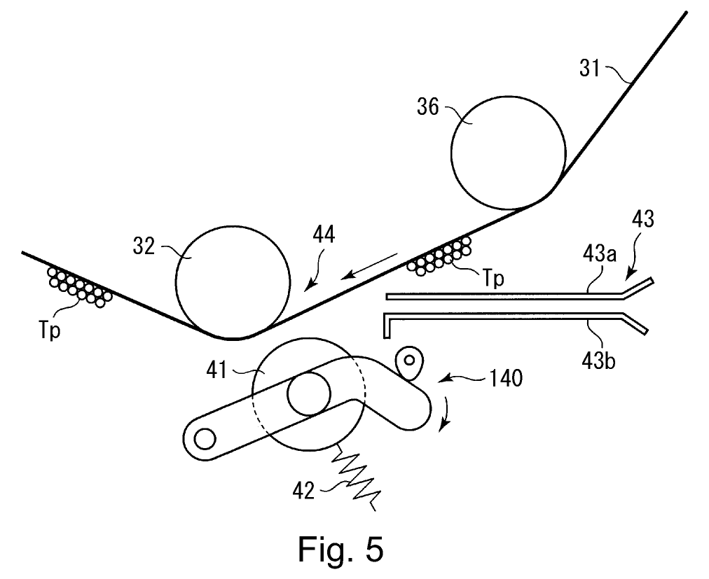

FIG. 5 is a schematic cross-sectional view illustrating a first mode of the secondary transfer portion N2 during the image correcting operation (upon forming the patch pattern on the intermediary transfer belt 31) (illustrating a cross section approximately perpendicular to the rotational axis direction of the secondary transfer inner roller 32.).

Upon forming patch patterns Tp on the intermediary transfer belt 31, the recording material S is not conveyed to the secondary transfer portion N2, and the secondary transfer outer roller 41 is separated from the intermediary transfer belt 31. Therefore, it becomes possible for the patch pattern Tp to pass through the secondary transfer portion N2 while keeping being carried on the intermediary transfer belt 31. As a result, adhesion of the toner to the secondary transfer outer roller 41 is suppressed, and adhesion of contamination due to the toner to a back surface of the recording material S during subsequent image formation is suppressed.

In a case in which a plurality of the patch patterns are formed on the intermediary transfer belt 31 in one image correcting operation, typically, from a predetermined timing before a frontmost portion of the plurality of patch patterns (a leading end of a first patch pattern) in the moving direction of the surface of the intermediary transfer belt 31 reaches a position corresponding to the secondary transfer portion N2 until a predetermined timing after a rearmost portion of the plurality of patch patterns (a trailing end of a last patch pattern) in the moving direction of the surface of the intermediary transfer belt 31 passes through the position corresponding to the secondary transfer portion N2, the secondary transfer outer roller 41 is separated from the intermediary transfer belt 31.

In a case in which this first mode is adopted, to the image forming apparatus 100, a contacting and separating mechanism 140 as a moving means, which causes the secondary transfer outer roller 41 to be in contact with and separated from the intermediary transfer belt 31, is provided.

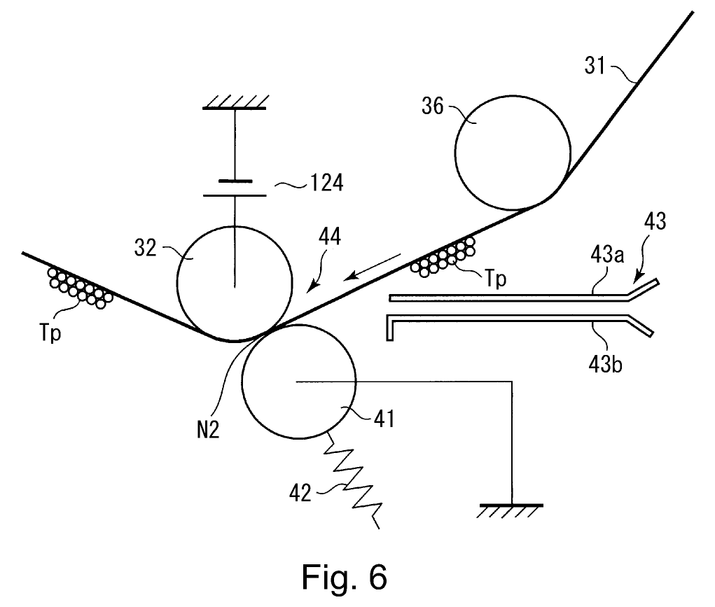

FIG. 6 is a schematic cross-sectional view illustrating a second mode of the secondary transfer portion N2 during image correcting operation (upon forming the patch patterns on the intermediary transfer belt 31) (illustrating a cross section approximately perpendicular to the rotational axis direction of the secondary transfer inner roller 32.).

Upon forming the patch patterns Tp on the intermediary transfer belt 31, the recording material S is not conveyed to the secondary transfer portion N2, and a voltage having positive polarity (+) (voltage having the opposite polarity to the normal charge polarity of the toner) is applied to the secondary transfer inner roller 32 by the secondary transfer power source 124. Therefore, the patch pattern Tp having electric charge of negative polarity (-) can pass through the secondary transfer portion N2 while keeping being carried on the intermediary transfer belt 31. By this, the adhesion of the toner to the secondary transfer outer roller 41 is suppressed, and the adhesion of contamination due to the toner to the back surface of the recording material S during subsequent image formation is suppressed.

In the case in which the plurality of patch patterns are formed on the intermediary transfer belt 31 in one image correcting operation, typically, from a predetermined timing before the frontmost portion of the plurality of patch patterns (leading end of the first patch pattern) in the moving direction of the surface of the intermediary transfer belt 31 reaches the secondary transfer portion N2 until a predetermined timing after the rearmost portion of the plurality of patch patterns (trailing end of the last patch pattern) in the moving direction of the surface of the intermediary transfer belt 31 passes through the secondary transfer portion N2, the voltage having positive polarity is applied to the secondary transfer inner roller 32.

In a case in which this second mode is adopted, the secondary transfer power source 124 is configured to be capable of applying both the voltage having negative polarity and the voltage having positive polarity to the secondary transfer inner roller 32.

In the present Embodiment, either of the first mode or the second mode described above may be adopted.

### Configuration of the belt cleaning device and a belt cleaning operation during image formation

Next, the belt cleaning device (hereinafter, also simply referred to as a “cleaning device”) 80 in the present Embodiment will be described.

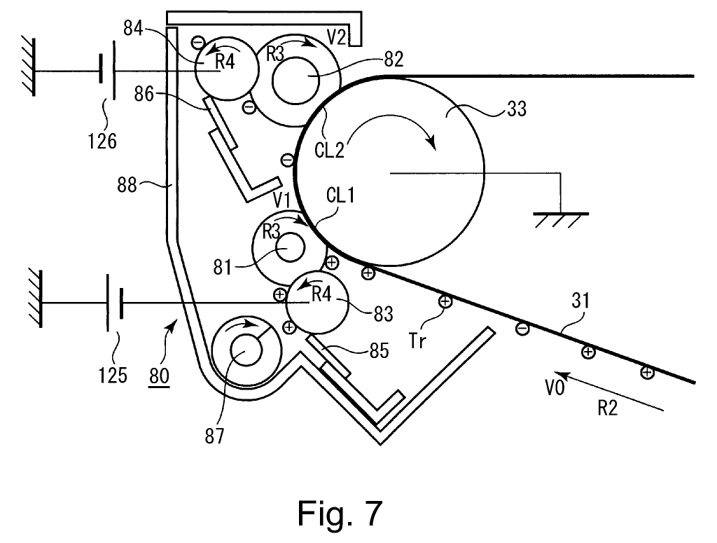

FIG. 7 is a schematic cross-sectional view of the cleaning device 80 during image formation (upon forming the print image on the intermediary transfer belt 31) in the present Embodiment (illustrating a cross section approximately perpendicular to the rotational axis direction of the secondary transfer inner roller 32.).

The cleaning device 80 is disposed, in the rotational direction of the intermediary transfer belt 31, on the downstream side of the secondary transfer portion N2 and the upstream side of the primary transfer portion N1 (upstreammost primary transfer portion N1Y). In the present Embodiment, the cleaning device 80 is disposed at a position opposite to the driving roller 33 via the intermediary transfer belt 31. In the present Embodiment, the cleaning device 80 employs an electrostatic cleaning type, particularly an electrostatic fur brush cleaning type, in which the toner on the intermediary transfer belt 31 is electrostatically collected.

The cleaning device 80 includes a housing 88 disposed in a vicinity of the intermediary transfer belt 31. Inside the housing 88, the following respective members are provided. First, a first and a second fur brushes (cleaning brushes) 81 and 82 as a first and a second cleaning members are provided. In addition, a first and a second bias rollers 83 and 84 as a first and a second collecting members (voltage applying members) are provided. In addition, a first and a second blades 85 and 86 as a first and a second scraping members are provided. In addition, a collected toner screw 87 as a toner conveyance member is provided.

The first and second fur brushes 81 and 82 are constituted by an electroconductive fur brush roller, which is rotatable electroconductive cleaning member having a brush shape, respectively. Brush fibers of the first and the second fur brushes 81 and 82 are constituted by nylon fibers of carbon dispersed type, acrylic fibers or polyester fibers, of which an electric resistance value of yarn is 3 × 10⁵ through 1 × 10¹³ Ω cm and a thickness of fiber is 2 through 15 denier, for example. And, the first and the second fur brushes 81 and 82 are constituted by planting the brush fibers (electroconductive fibers) on a metal roller as a base material (core metal, core material) at a ratio of a bristle density of 50,000 through 500,000 fibers/inch², for example. Lengths of the brush fibers are configured to be, for example, about 3 through 5 mm. The first and the second fur brushes 81 and 82 are disposed so as to be in contact with the intermediary transfer belt 31. In the present Embodiment, the first and the second fur brushes 81 and 82 are disposed with keeping an entering amount of about 1.0 through 2.0 mm with respect to the intermediary transfer belt 31. Incidentally, this entering amount is represented by a value obtained by subtracting a shortest distance between the base material of the fur brush and the intermediary transfer belt 31 from the length of the brush fiber. In addition, the first and the second fur brushes 81 and 82 are rotationally driven, by driving force from a cleaning motor 133a of the cleaning driving portion 133 (FIG. 3) as a cleaning driving means being transmitted, in a direction of an arrow R3 (clockwise direction) in FIG. 7. In other words, the first and the second fur brushes 81 and 82 is rotated so as to be moved in a counter direction with respect to the moving direction of the surface of the intermediary transfer belt 31, in other words, in an opposite direction to the moving direction of the intermediary transfer belt 31 at a contacting portion (contacting position) with the intermediary transfer belt 31. As a result, the first and the second fur brushes 81 and 82 rub the surface of the intermediary transfer belt 31.

In the present Embodiment, the first and the second fur brushes 81 and 82 are brought into contact, via the intermediary transfer belt 31, with the driving roller 33 functioning as an opposite member. The driving roller 33 is connected to the ground (electrically grounded). Rotational axis directions of the first and the second fur brushes 81 and 82 are approximately parallel to a widthwise direction of the intermediary transfer belt 31 (the rotational axis direction of the secondary transfer inner roller 32). Lengths of the first and the second fur brushes 81 and 82 in the rotational axis directions thereof are longer than a width of an area, in which the toner image on the intermediary transfer belt 6 is to be formed, in the widthwise direction of the intermediary transfer belt 31. The contacting portion between the first fur brush 81 and the intermediary transfer belt 31 is a first cleaning portion CL1 in which removal of the toner from the intermediary transfer belt 31 by the first fur brush 81 is performed. In addition, the contacting portion between the second fur brush 82 and the intermediary transfer belt 31 is a second cleaning portion CL2 in which the removal of the toner from the intermediary transfer belt 31 by the second fur brush 82 is performed. The first and the second cleaning portions CL1 and CL2 are positioned, in the rotational direction of the intermediary transfer belt 31, on the downstream side of the secondary transfer portion N2 and the upstream side of the primary transfer portion N1 (upstreammost primary transfer portion N1Y). In addition, in the present Embodiment, in the moving direction of the surface of the intermediary transfer belt 31, the first cleaning portion CL1 is positioned on an upstream side of the second cleaning portion CL2, and the second cleaning portion CL2 is positioned on a downstream side of the first cleaning portion CL1. In other words, in the present Embodiment, in the moving direction of the surface of the intermediary transfer belt 31, the first fur brush 81 is positioned on the upstream side of the second fur brush 82, and the second fur brush 82 is positioned on the downstream side of the first fur brush 81.

The first and the second bias rollers 83 and 84 are constituted by a rotatable roller made of metal (metal roller) (for example, made of aluminum). The first and the second bias rollers 83 and 84 are disposed so as to be in contact with the first and the second fur brushes 81 and 82, respectively. In the present Embodiment, the first and the second bias rollers 83 and 84 are disposed with keeping an entering amount of about 1.5 through 2.5 mm with respect to the first and the second fur brushes 81 and 82, respectively. In addition, the first and the second bias rollers 83 and 84 are rotationally driven, by driving force from the cleaning motor 133a of the cleaning driving portion 133 (FIG. 3) as a driving means being transmitted, in a direction of an arrow R4 (counterclockwise direction) in FIG. 7. In other words, the first and the second bias rollers 83 and 84 are rotated so as to be moved in with directions with respect to the rotational directions of the first and the second fur brushes 81 and 82, in other words, in forward directions with moving directions of the first and the second fur brushes 81 and 82 at the contacting portions with the first and the second fur brushes 81 and 82, respectively. Rotational axis directions of the first and the second bias rollers 83 and 84 are approximately parallel to the widthwise direction of the intermediary transfer belt 6 (rotational axis direction of the secondary transfer inner roller 32). Lengths of the first and the second bias rollers 83 and 84 in the rotational axis directions thereof are approximately the same as the lengths of the first and the second fur brushes 81 and 82 in the rotational axis directions thereof.

The first and the second blades 85 and 86 are disposed so as to be in contact with the first and the second bias rollers 83 and 84, respectively. The first and the second blades 85 and 86 are formed of a rubber material such as urethane rubber as an elastic member. The first and the second blades 85 and 86 are members having a plate shape, which has predetermined lengths in a longitudinal direction, which is disposed approximately parallel to the rotational axis directions of the first and the second bias rollers 83 and 84, and in a short direction, which is approximately perpendicular to the longitudinal direction, respectively, and has a predetermined thickness. The first and the second blades 85 and 86 are brought into contact, in respective counter directions to the rotational directions of the first and the second bias rollers 83 and 84 (respective directions in which free end portions thereof face upstream sides of the rotational directions), with the first and the second bias rollers 83 and 84 . Lengths of the first and the second blades 85 and 86 in the longitudinal directions thereof are approximately the same as the lengths of the first and the second bias rollers 83 and 84 in the rotational axis directions thereof.

In the present Embodiment, to the first fur brush 81, which is positioned on the upstream side in the moving direction of the surface of the intermediary transfer belt 31, a first cleaning bias (first cleaning voltage) having negative polarity (-), which is the same polarity as the normal charge polarity of the toner, is applied. In the present Embodiment, by the first cleaning power source (high voltage power source) 125, a direct current voltage having negative polarity (-) is applied to the first bias roller 83. As a result, via the first bias roller 83, the direct current voltage having negative polarity (-) is applied to the first fur brush 81. On the other hand, in the present Embodiment, to the second fur brush 82, which is positioned on the downstream side in the moving direction of the surface of the intermediary transfer belt 31, a second cleaning bias (second cleaning voltage) having positive polarity (+), which is the opposite polarity to the normal charge polarity of the toner, is applied. In the present Embodiment, by the second cleaning power source (high voltage power source) 126, a direct current voltage having positive polarity (+) is applied to the second bias roller 84. As a result, via the second bias roller 84, the direct current voltage having positive polarity (+) is applied to the second fur brush 82.

Most of the transfer residual toner Tr having passed through the secondary transfer portion N2 is charged to positive polarity (+). This is because most of the transfer residual toner Tr is the toner having positive polarity (+), which remains on the intermediary transfer belt 31 without being transferred to the recording material S by the secondary transfer bias having positive polarity (+). This transfer residual toner Tr is electrostatically attracted, along with the rotation of the intermediary transfer belt 31, to the first fur brush 81, to which the first cleaning bias having negative polarity (-) is applied, and is removed from the intermediary transfer belt 31. For example, when a voltage of -3.5 kV is applied to the first bias roller 83, a potential of the first fur brush 81 becomes -2.0 kV, and the transfer residual toner Tr having positive polarity (+) on the intermediary transfer belt 31 is transferred from the intermediary transfer belt 31 to the first fur brush 81. The toner transferred to the first fur brush 81 is transferred from the first fur brush 81 to the first bias roller 83 due to a potential difference between the first fur brush 81 and the first bias roller 83. The toner transferred to the first bias roller 83 is scraped off from the first bias roller 83 by the first blade 85.

As described above, the transfer residual toner Tr on the intermediary transfer belt 31 is removed from the intermediary transfer belt 31 by the first fur brush 81. However, there is a possibility that the transfer residual toner Tr still remains on the intermediary transfer belt 31 after passing through the first cleaning portion CL1. The transfer residual toner Tr having passed through the first cleaning portion CL1 is charged to negative polarity (-) by the first cleaning bias having negative polarity (-), which is applied to the first fur brush 81. This is considered to be because the toner is charged by electric charge injection or electric discharge.

The transfer residual toner Tr having passed through the first cleaning portion CL1 is electrostatically attracted, along with the rotation of the intermediary transfer belt 31, to the second fur brush 82, to which the second cleaning bias having positive polarity (+) is applied, and is removed from the intermediary transfer belt 31. By this, it becomes possible to remove the transfer residual toner Tr, which could not be removed from the intermediary transfer belt 31 by the first fur brush 81, from the intermediary transfer belt 31 by the second fur brush 82. For example, when a voltage of +3.5 kV is applied to the second bias roller 84, a potential of the second fur brush 82 becomes +2.0 kV, and the transfer residual toner Tr having negative polarity (-) on the intermediary transfer belt 31 is transferred from the intermediary transfer belt 31 to the second fur brush 82. The toner transferred to the second fur brush 82 is transferred from the second fur brush 82 to the second bias roller 84 due to a potential difference between the second fur brush 82 and the second bias roller 84. The toner transferred to the second bias roller 84 is scraped off from the second bias roller 84 by the second blade 86.

Incidentally, the first and the second cleaning biases may be appliedput under constant voltage control or constant current control. It is sufficient that a sufficient cleaning current (for example, 10 through 80 μA in absolute value) can be supplied to the first and the second cleaning portions CL1 and CL2. Here, the constant current control is a control in which an output of a power source is adjusted so that a current supplied to a supplying target becomes approximately constant at a target current. In addition, the constant voltage control is a control in which an output of a power source is adjusted so that a voltage applied to an applying target becomes approximately constant at a target voltage.

The toner scraped off from the first and the second bias rollers 83 and 84 by the first and the second blades 85 and 86 is accommodated in the housing 88. The toner accommodated in the housing 88 is conveyed by the collected toner screw 87 provided in the housing 88, and is discharged from the housing 88. The collected toner screw 87 is rotationally driven by driving force from the cleaning motor 133a of the cleaning driving portion 133 (FIG. 3) as a driving means being transmitted. The toner discharged from the housing 88 is conveyed, via a conveyance path (not shown) provided in the image forming apparatus 100, to a collected toner container (not shown) provided in the image forming apparatus 100, for example, and collected in the collected toner container.

In the present Embodiment, the first fur brush 81, the second fur brush 82, the first bias roller 83, the second bias roller 84 and the collected toner screw 87 are connected through drive by a gear train. And these are driven by the common cleaning motor 133a of the cleaning driving portion 133 (FIG. 3). Here, a peripheral speed of the first fur brush 81 is defined as V1, and a peripheral speed of the second fur brush 82 is defined as V2. Incidentally, the peripheral speeds of the first and the second fur brushes 81 and 82 are represented by moving speeds of the first and the second fur brushes 81 and 82 at the contacting portions with the intermediary transfer belt 31 (surface positions on the intermediary transfer belt at which distances between the base materials of the fur brushes and the intermediary transfer belt become shortest distances), respectively.

In addition, in the present Embodiment, the driving roller 33, which conveys (rotates) the intermediary transfer belt 31, is driven by the belt driving motor 132a of the belt driving portion 132 (FIG. 3). A conveyance speed (moving speed of the surface) of the intermediary transfer belt 31 is defined as V0.

In the present Embodiment, the peripheral speeds (numbers of rotations, rotation speeds) of the first and the second fur brushes 81 and 82 upon removing the transfer residual toner Tr from the intermediary transfer belt 31 by the cleaning device 80 are set as follows by a number of rotation (rpm) of the cleaning motor 133a. That is, the number of rotations of the cleaning motor 133a is set to a first number of rotations Nr so that the peripheral speed V1 of the first fur brush 81 and the peripheral speed V2 of the second fur brush 82 have a following relationship with respect to the conveyance speed V0 of the intermediary transfer belt 31.

V1 = 0.25 × V0

V2 = 0.25 × V0

This is a setting necessary for sufficiently removing the transfer residual toner Tr having an assumed maximum density from the intermediary transfer belt 31 (substantially without leaving the toner on the intermediary transfer belt 31). When the peripheral speeds V1 and V2 of the first and the second fur brushes 81 and 82 are set larger than these, a number of times, for which the first and the second fur brushes 81 and 82 and the intermediary transfer belt 31 are rubbed against each other, increases, so that there is a possibility that parts life of the intermediary transfer belt 31, the first and the second fur brushes 81 and 82, etc. are shortened due to abrasion, etc.

### Belt cleaning operation during image correcting operation

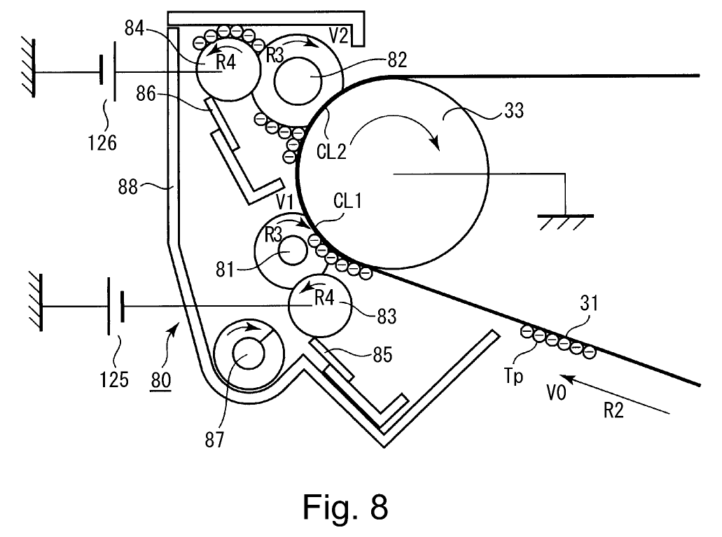

FIG. 8 is a schematic cross-sectional view of the cleaning device 80 during image correcting operation in the present Embodiment (upon forming the patch patterns on the intermediary transfer belt 31) (illustrating the cross section approximately perpendicular to the rotational axis direction of the secondary transfer inner roller 32).

Most of the toner of the patch pattern Tp having passed through the secondary transfer portion N2 is charged to negative polarity (-). This is because due to a fact that the patch pattern Tp passes through the secondary transfer portion N2 in substantially an intact state upon being transferred onto the intermediary transfer belt 31. Therefore, the patch pattern Tp passes through the first cleaning portion CL1 without being transferred to the first fur brush 81, to which the first cleaning bias having negative polarity (-) is applied. Then, when the patch pattern Tp reaches the second cleaning portion CL2, the patch pattern Tp is transferred to the second fur brush 82, to which the second cleaning bias having positive polarity (+) is applied. The toner transferred to the second fur brush 82 is accommodated, in the same manner as the operation during image formation described above, in the housing 88, and collected in the collected toner container (not shown).

Since the patch pattern Tp is not transferred to the recording material S, a toner density (toner amount per unit area) thereof is larger than that of the transfer residual toner Tr. Therefore, in order to remove the patch pattern Tp from the intermediary transfer belt 31 sufficiently (substantially without leaving the patch pattern Tp on the intermediary transfer belt 31), it is necessary to increase the number of times, for which the electroconductive fibers constituting the second fur brush 82 and the surface of the intermediary transfer belt 31 are contacted to and rubbed against each other. In other words, upon removing the patch pattern Tp from the intermediary transfer belt 31, it is necessary to set the peripheral speed V2 of the second fur brush 82 larger than upon removing the transfer residual toner Tr from the intermediary transfer belt 31. In the present Embodiment, the peripheral speed of the second fur brush 82 upon removing the patch pattern Tp from the intermediary transfer belt 31 by the cleaning device 80 is set, by the number of rotations of the cleaning motor 133a, as follows. That is, the number of rotations of the cleaning driving motor 133a is set to a second number of rotations Np so that the peripheral speed V2 of the second fur brush 82 has a following relationship with respect to the conveyance speed V0 of the intermediary transfer belt 31.

V2 = 0.5 × V0

In this manner, in the present Embodiment, the second number of rotations Np of the cleaning motor 133a during image correcting operation (upon removing the patch pattern Tp) is larger than the first number of rotations Nr of the cleaning motor 133a during image formation (upon removing the transfer residual toner Tr) (Np > Nr). In other words, in the present Embodiment, the number of rotations of the cleaning motor 133a is switched during image formation and during image correcting operation.

In the present Embodiment, the first fur brush 81, the second fur brush 82, the first bias roller 83, the second bias roller 84 and the collected toner screw 87 are connected through drive by the gear train. Therefore, during image correcting operation, the numbers of rotations thereof also become larger than during image formation. In other words, in the present Embodiment, during image correcting operation, the peripheral speeds V1 and V2 of the first and the second fur brushes 81 and 82 are set, by the number of rotations of the cleaning motor 133a, as follows.

V1 = 0.5 × V0

V2 = 0.5 × V0

Here, in the present Embodiment, the conveyance speed V0 of the intermediary transfer belt 31 is substantially the same during image formation (upon removing the transfer residual toner Tr) and during image correcting operation (upon removing the patch pattern Tp). In addition, in the present Embodiment, the settings for the first and the second cleaning biases are substantially the same during image formation (upon removing the transfer residual toner Tr) and during image correcting operation (upon removing the patch pattern Tp), however, the settings may be different.

Incidentally, the first number of rotations Nr of the cleaning motor 133a is represented by the number of rotations of the cleaning motor 133a upon removing the transfer residual toner Tr from the intermediary transfer belt 31 by the second fur brush 82. In other words, the first number of rotations Nr of the cleaning motor 133a is represented by the number of rotations of the cleaning motor 133a in a period in which the image forming area (area in which the print image is to be formed) on the intermediary transfer belt 31 during image formation is passing through the second cleaning portion CL2.

In addition, the second number of rotations Np of the cleaning motor 133a is represented by the number of rotations of the cleaning motor 133a upon removing the patch pattern Tp from the intermediary transfer belt 31 by the second fur brush 82. In other words, the second number of rotations Np of the cleaning motor 133a is represented by the number of rotations of the cleaning motor 133a in a period in which an area in which the patch pattern Tp is formed on the intermediary transfer belt 31 during image correcting operation is passing through the second cleaning portion CL2. The period in which the area in which the patch pattern Tp is formed passes through the second cleaning portion CL2 may be, in a case in which a plurality of the patch patterns Tp are formed on the intermediary transfer belt 31 in one image correcting operation, a period from when the frontmost portion of the plurality of patch patterns in the moving direction of the surface of the intermediary transfer belt 31 reaches the second cleaning portion CL2 until when the rearmost portion of the plurality of patch patterns in the moving direction of the surface of the intermediary transfer belt 31 finishes passing through the second cleaning portion CL2.

In addition, it may be rephrased as follows. That is, the peripheral speed of the second fur brush 82 during image formation (upon removing the transfer residual toner Tr) is defined as a first peripheral speed Vr, and the peripheral speed of the second fur brush 82 during image correcting operation (upon removing the patch pattern Tp) is defined as a second peripheral speed Vp. In this case, in the present Embodiment, the second peripheral speed Vp is faster than the first peripheral speed Vr (Vp > Vr). In other words, in the present Embodiment, the peripheral speed of the second fur brush 82 is switched during image formation and during image correcting operation. To put it further differently, in the present Embodiment, a ratio Vp/V0 of the peripheral speed of the second fur brush 82 to the conveyance speed V0 of the intermediary transfer belt 31 during image correcting operation (upon removing the patch pattern Tp) is larger than a ratio Vr/V0 during image formation (upon removing the transfer residual toner Tr) (Vp/V0 > Vr/V0). In other words, in the present Embodiment, the ratio is switched between during image formation and during image correcting operation. The peripheral speed of the second fur brush 82 may be changed (controlled), typically, by changing (controlling) the number of rotations of the driving motor as in the present Embodiment. However, it is not limited thereto, but it may be configured that the peripheral speed of the second fur brush 82 is changed (controlled) by a speed changing mechanism as a speed changing means provided in a drive transmitting portion which transmits drive from the driving motor to the second fur brush 82. In addition, from a viewpoint of a longer life of members and cleaning performance, etc., it is suitable that the first peripheral speed Vr be 20% or more and 80% or less of the second peripheral speed Vp (0.2 × Vp ≦ Vr ≦ 0.8 × Vp). Typically, the first peripheral speed Vr is 30% or more and 70% or less of the second peripheral speed Vp (0.3 × Vp ≦ Vr ≦ 0.7 × Vp). Incidentally, as described above, in the present Embodiment, in conjunction with the second fur brush 82, the peripheral speed of the first fur brush 81 during image correcting operation (upon removing the patch pattern Tp) becomes faster than the peripheral speed of the first fur brush 81 during image formation (upon removing the transfer residual toner Tr).

### Switching timing of cleaning speed

Upon switching the number of rotations of the cleaning motor 133a, since the peripheral speeds V1 and V2 of the first and the second fur brushes 81 and 82 are changed, driving load for the intermediary transfer belt 31 is changed. By this, there is a possibility that the conveyance speed V0 of the intermediary transfer belt 31 and a rotation speed of the photosensitive drum 11, which is driven by being in contact with the intermediary transfer belt 31, are temporarily fluctuated. Therefore, if the switching of the number of rotations of the cleaning motor 133a is performed during image formation (during secondary transfer of the print image, during exposure of the print image), image defect such as a widthwise streak (shock image) may occur.

In order to suppress the occurrence of such an image defect, it is preferable to perform the switching of the number of rotations of the cleaning motor 133a (peripheral speeds V1 and V2 of the first and the second fur brushes 81 and 82) at timings as follows.

That is, in a case in which the number of rotations of the cleaning motor 133a (peripheral speeds V1 and V2 of the first and the second fur brushes 81 and 82) is switched in a state in which the photosensitive drum 11 and the intermediary transfer belt 31 are being rotated, it is preferable that the switching be performed during non-image formation, i.e., at timings when the formation (exposure, development) of the print image, the primary transfer of the print image and the secondary transfer of the print image are not performed.

For example, it is preferable that the switching of the number of rotations of the cleaning motor 133a from the first number of rotations Nr to the second number of rotations Np be performed after the recording material S, on which a last print image immediately before the interruption of the image correcting operation is to be formed, finishes passing through the secondary transfer portion N2. In other words, it is preferable that the switching of the peripheral speed of the second fur brush 82a from the first peripheral speed Vr to the second peripheral speed Vp be performed after the recording material S, on which the last print image immediately before the interruption of the image correcting operation is to be formed, finishes passing through the secondary transfer portion N2. By this, it becomes possible to suppress the occurrence of image defect such as a widthwise streak due to the fluctuation in the conveyance speed of the intermediary transfer belt 31 due to the change in the driving load for the intermediary transfer belt 31 as described above.

In addition, for example, it is preferable that the switching of the number of rotations of the cleaning motor 133a from the second number of rotations Np to the first number of rotations Nr be performed before the exposure (writing of the image) associated with the print image, which is to be formed on a first recording material S immediately after the interruption of the image correcting operation, is started. In other words, it is preferable that the switching of the peripheral speed of the second fur brush 82 from the second peripheral speed Vp to the first peripheral speed Vr be performed before the exposure (writing of the image) associated with the print image, which is to be formed on the first recording material S immediately after the interruption of the image correcting operation, is started. By this, it becomes possible to suppress the occurrence of image defect such as a widthwise streak due to the fluctuation in the conveyance speed of the intermediary transfer belt 31 due to the change in the driving load for the intermediary transfer belt 31 and the fluctuation in the rotational speed of the photosensitive drum 11 as described above.

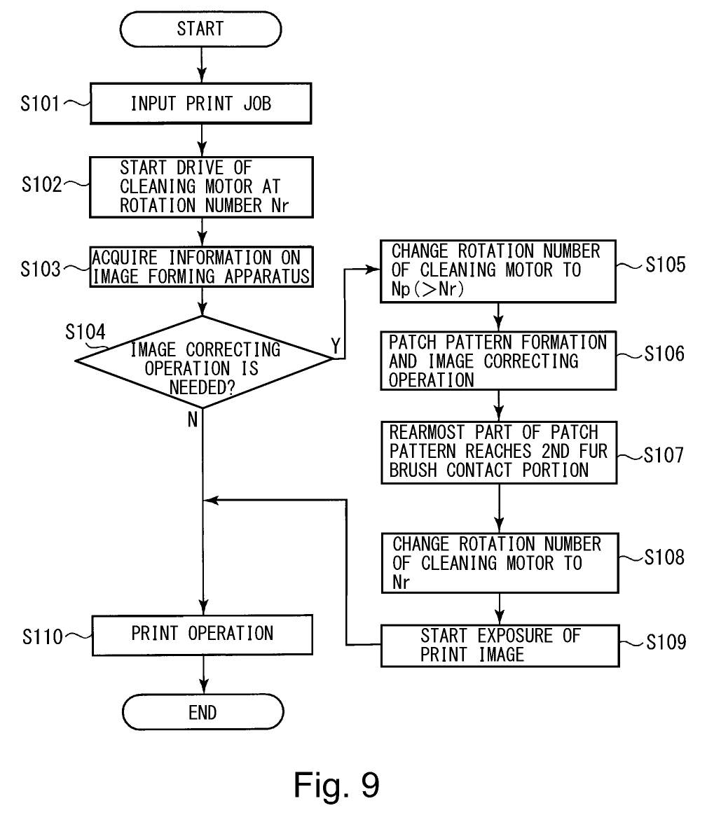

Using FIG. 9, a switching operation for the number of rotations (driving speed) of the cleaning motor 133a associated with the image correcting operation, which is performed before the image forming operation, will be further described. FIG. 9 is a flowchart diagram for describing a control for this operation.

When a print job is input to the image forming apparatus 100 (S101), the control portion 110 starts the driving of the photosensitive drum 11 and the intermediary transfer belt 31, and controls so as to start the driving of the cleaning motor 133a at the first number of rotations Nr (S102). To the image forming apparatus 100, based on an operation from a user through the external device such as a host computer, the print job is input. Thereafter, the control portion 110 acquires information of the image forming apparatus 100 such as a standby time from a previous print job (S103), and determines whether or not the image correcting operation is necessary based on the information (S104). This is because, there is a possibility that due to a charge amount of the toner in the developing device 14 changing when the standby time becomes long, for example, a density of the print image comes out of a proper density with a setting for the previous print job as it is. The control portion 110 may obtain the standby time of the image forming apparatus 100, for example, from an end time of the previous print job and a start time of a current print job stored in the memory 112 (non-volatile memory). And, if the standby time exceeds a predetermined time, for example, then the control portion 110 determines that image density control is necessary.

If the control portion 110 determines that the image correcting operation (image density control) is not necessary in S104, then the control portion 110 proceeds the process to a process of S110. On the other hand, if the control portion 110 determines that the image correcting operation (image density control) is necessary in S104, then the control portion 110 controls to cause the number of rotations of the cleaning motor 133a to be increased from the first number of rotations Nr to the second number of rotations Np (S105). Thereafter, the control portion 110 controls so as to perform the formation of the density patch pattern for the image density control and the operation for the image density control described above (S106). Incidentally, this timing to increase the speed of the cleaning motor 133a is a timing before the frontmost portion of the patch pattern on the intermediary transfer belt 31 reaches the second cleaning portion CL2 (in the present Embodiment, before the exposure of the photosensitive drum 11 for forming the patch pattern).

Thereafter, after the rearmost portion of the patch pattern on the intermediary transfer belt 31 reaches the second cleaning portion CL2 (S107), the control portion 110 controls to cause the number of rotations of the cleaning motor 133a to be decreased from the second number of rotations Np to the first number of rotations Nr (S108). By this, the patch pattern is properly removed from the intermediary transfer belt 31.

Then, after the number of rotations of the cleaning motor 133a is switched to the first number of rotations Nr, the control portion 110 starts the exposure of the print image by the exposing device 13 (S109). In other words, the control portion 110 controls so as to start, from the upstreammost image forming portion 1Y in the moving direction of the surface of the intermediary transfer belt 31, by causing the photosensitive drum 11Y to be irradiated with the laser light by the exposing device 13Y, the formation of the electrostatic latent image of the print image on the surface of the photosensitive drum 11Y. Thereafter, the control portion 110 controls so as to perform the secondary transfer of the print image (print operation) (S110).

By this, it becomes possible to suppress that the conveyance speed of the intermediary transfer belt 31 and the rotational speed of the photosensitive drum 11 are temporarily fluctuated, and suppress the occurrence of image defect such as a widthwise streak in the print image (a product). Thereafter, the control portion 110 terminates the print job.

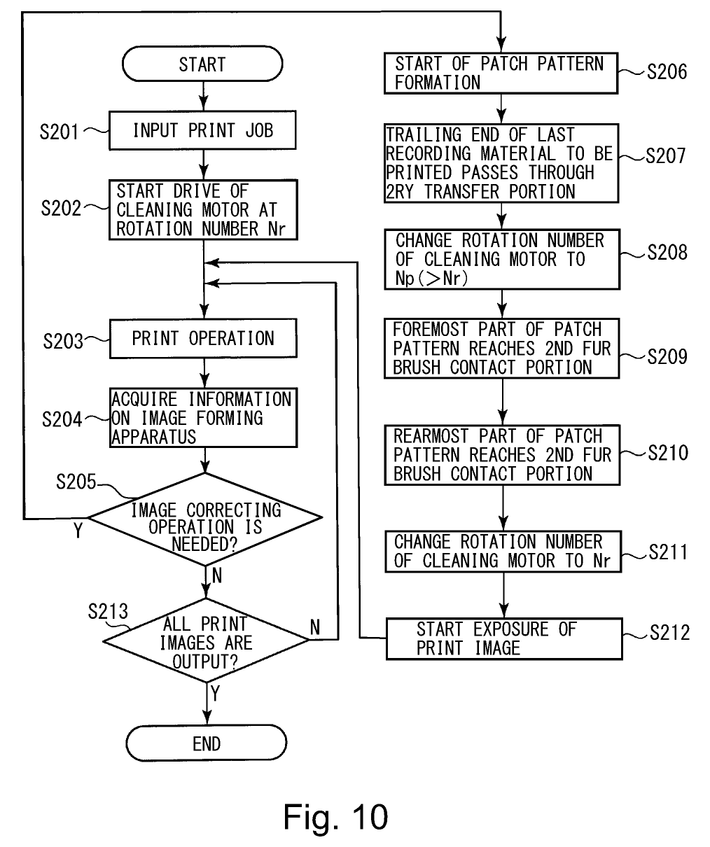

Next, using FIG. 10, a switching operation for the number of rotations (driving speed) of the cleaning motor 133a associated with an image correcting operation performed in a middle of continuous printing will be further described. FIG. 10 is a flowchart diagram for describing a control for this operation.

When a print job is input to the image forming apparatus 100 (S201), the control portion 110 starts the driving of the photosensitive drum 11 and the intermediary transfer belt 31, and controls so as to start the driving of the cleaning motor 133a at the first number of rotations Nr (S202). To the image forming apparatus 100, based on the operation from the user through the external device such as a host computer, the print job is input. Thereafter, the control portion 110 controls so as to perform the formation of the print image and the secondary transfer of the print image (print operation) (S203). Thereafter, the control portion 110 acquires information of the image forming apparatus 100 such as a temperature of the exposing device 13 (S204), for example, and determines whether or not the image correcting operation is necessary based on the information (S205). The control portion 110 acquires, for example, a detection result of the temperature of the exposing device 13 from a temperature sensor (not shown) as a temperature detecting means provided to the exposing device 13. And if a temperature rise (ΔT) of the exposing device 13 becomes ΔT > 3℃, for example, then the control portion 110 determines that the color misregistration correcting control is necessary.

If the control portion 110 determines that the image correcting operation (color misregistration correcting control) is not necessary in S205, then the control portion 110 proceeds the process to a process of S213. On the other hand, if the control portion 110 determines that the image correcting operation (color misregistration correcting control) is necessary in S205, then the control portion 110 starts the formation of the registration patch pattern for the color misregistration correcting control described above (S206). Incidentally, the control portion 110 appropriately performs an operation for the color misregistration correcting control such as detection of the patch pattern thereafter. Then, after the trailing end of the recording material S, onto which a last print image formed before the formation of the patch pattern is started has been secondarily transferred, passes through the secondary transfer portion N2 (S207), the control portion 110 controls to cause the number of rotations of the cleaning motor 133a to be increased from the first number of rotations Nr to the second number of rotations Np (S208). Incidentally, this timing to increase the speed of the cleaning motor 133a is a timing before the frontmost portion of the patch pattern on the intermediary transfer belt 31 reaches the second cleaning portion CL2. By this, it becomes possible to suppress the fluctuation of the conveyance speed of the intermediary transfer belt 31 while the recording material S is passing through the secondary transfer portion N2, and suppress the occurrence of image defect such as a widthwise streak in the print image, which is secondarily transferred to the recording material S.

Thereafter, after the frontmost portion of the patch pattern on the intermediary transfer belt 31 reaches the second cleaning portion CL2 (S209) and further the rearmost portion of the patch pattern on the intermediary transfer belt 31 reaches the second cleaning portion CL2 (S210), the control portion 110 controls to cause the number of rotations of the cleaning motor 133a to be decreased from the second number of rotations Np to the first number of rotations Nr (S211). By this, the patch pattern is properly removed from the intermediary transfer belt 31.

Then, after the number of rotations of the cleaning motor 133a is switched to the first number of rotations Nr, the control portion 110 starts (resumes) the exposure of the print image by the exposing device 13 (S212). In other words, the control portion 110 controls so as to start, from the upstreammost image forming portion 1Y in the moving direction of the surface of the intermediary transfer belt 31, by causing the photosensitive drum 11Y to be irradiated with the laser light by the exposing device 13Y, the formation of the electrostatic latent image of the print image on the surface of the photosensitive drum 11Y. Thereafter, the control portion 110 controls so as to perform the secondary transfer of the print image (print operation) (S203). By this, it becomes possible to suppress that the conveyance speed of the intermediary transfer belt 31 and the rotational speed of the photosensitive drum 11 are temporarily fluctuated, and suppress the occurrence of image defect such as a widthwise streak in the print image (product). In addition, if output for all print images in the print job is completed (S213), the control portion 110 terminates the print job.

In this manner, in the present Embodiment, the image forming apparatus 100 includes the image forming portion 1, which is provided with the rotatable image bearing member (photosensitive drum) 11, which bears the toner image, and forms the toner image on the image bearing member 11, the rotatable intermediary transfer belt 31 to which the toner image is transferred from the image bearing member 11 and which forms the primary transfer portion N1 where the toner image is primarily transferred to the intermediary transfer belt 31 from the image bearing member 11 and the secondary transfer portion N2 where the toner image is secondarily transferred to the recording material S from the intermediary transfer belt 31, the brush (second fur brush) 82, which is in contact with the intermediary transfer belt 31 at the cleaning portion (second cleaning portion) CL2 on the downstream side of the secondary transfer portion N2 and the upstream side of the primary transfer portion N1 with respect to the rotational direction of the intermediary transfer belt 31, and removes the toner from the intermediary transfer belt 31 by electrostatically attracting the toner while rotating, the driving portion (cleaning driving portion) 133 which drives the brush 82, and the control portion 110 capable of controlling the driving portion 133, wherein the control portion 110 is capable of performing control so as to execute the image forming operation in which the toner image formed on the intermediary transfer belt 31 is transferred to the recording material S by the image forming portion 1 and the adjusting operation in which the adjustment toner image (patch pattern) is formed on the intermediary transfer belt 31 by the image forming portion 1, and controls the driving portion 133 in the image forming operation so that the brush 82 is rotated at the first peripheral speed Vr when the transfer residual toner Tr remaining on the intermediary transfer belt 31 is removed from the intermediary transfer belt 31 by the brush 82, and the brush 82 is rotated at the second peripheral speed Vp faster than the first peripheral speed Vr when the adjustment toner image is removed from the intermediary transfer belt 31 by the brush 82.

In the present Embodiment, the control portion 110 controls the driving portion 133 so that the motor (cleaning motor) 133a, which is provided to the driving portion 133, is rotated at the first number of rotations Nr when the transfer residual toner is removed from the intermediary transfer belt 31 by the brush 82, and the motor 133a is rotated at the second number of rotations Np larger than the first number of rotations Nr when the adjustment toner image is removed from the intermediary transfer belt 31 by the brush 82. Here, the image forming portion 1 includes the exposing device 13 which exposes the image bearing member 11 and forms the electrostatic image on the image bearing member 11, and the developing device 14 which supplies the toner to the electrostatic image formed on the image bearing member 11 and forms the toner image on the image bearing member 11. In this case, it is preferable that upon executing the image forming operation after executing the adjusting operation, the control portion 110 control the timing to change the number of rotations of the motor 133a from the second number of rotations Np to the first number of rotations Nr so as to be the timing after the rearmost portion of the adjustment toner image, which is formed in the adjusting operation, in the moving direction of the surface of the intermediary transfer belt 31 has reached the cleaning portion CL2 and before the formation of the electrostatic image by the exposing device 13 in the image forming operation is started. In addition, it is preferable that upon executing the adjusting operation after executing the image forming operation, the control portion 110 control the timing to change the number of rotations of the motor 133a from the first number of rotations Nr to the second number of rotations Np so as to be the timing after the last recording material S in the image forming operation passes through the secondary transfer portion N2 and before the frontmost portion of the adjustment toner image, which is formed in the adjusting operation, in the moving direction of the surface of the intermediary transfer belt 31 reaches the cleaning portion CL2. Incidentally, it may be rephrased that it is preferable that upon executing the image forming operation after executing the adjusting operation, the timing to change the peripheral speed of the brush 82 from the second peripheral speed Vp to the first peripheral speed Vr be the same timing as described above. In addition, it may be rephrased that it is preferable that upon executing the adjusting operation after executing the image forming operation, the timing to change the peripheral speed of the brush 82 from the first peripheral speed Vr to the second peripheral speed Vp be the same timing as described above.

In addition, in the present Embodiment, the image forming apparatus 100 includes the applying portion (second cleaning power source) 126 which applies the bias having positive polarity (+), which moves the toner charged to the normal charge polarity (-) of the toner from the intermediary transfer belt 31 to the brush 82, to the cleaning portion CL2. In addition, in the present Embodiment, the image forming apparatus 100 includes the other brush (first fur brush) 81, which is in contact with the intermediary transfer belt 31 at the other cleaning portion (first cleaning portion) CL1 on the downstream side of the secondary transfer portion N2 and the upstream side of the primary transfer portion N1 in the rotational direction of the intermediary transfer belt 31 and removes the toner from the intermediary transfer belt 31 by electrostatically attracting the toner while rotating, and the other applying portion (first cleaning power source) 125 which applies the bias having negative polarity (-), which moves the toner charged to the opposite polarity (+) to the normal charge polarity of the toner from the intermediary transfer belt 31 to the other brush 81, to the other cleaning portion CL1, and the driving portion 133 drives the brush 82 and the other brush 81, and when the brush 82 is rotated at the first peripheral speed, the other brush 81 is rotated at a third peripheral speed, and when the brush 82 is rotated at the second peripheral speed, the other brush 81 is rotated at a fourth peripheral speed faster than the third peripheral speed.

As described above, according to the present Embodiment, it becomes possible, while enabling to properly remove the patch pattern from the intermediary transfer belt 31, to achieve the longer life of the parts including the intermediary transfer belt 31 and the first and the second fur brushes 81 and 82, etc.

### OTHER EMBODIMENTS

As described above, the present invention has been described according to the specific Embodiments, however, the present invention is not limited to the Embodiments described above.

In the Embodiments described above, the driving roller 33 is used as the common opposite roller for the first and the second fur brushes 81 and 82, however, it may be configured that opposite rollers are provided independently to each of the first and the second fur brushes 81 and 82.

In addition, in the Embodiments described above, the voltage is applied to the first and the second bias rollers 83 and 84, however, a supplying method of the cleaning current is not limited thereto. For example, rollers opposite to the first and the second fur brushes 81 and 82 via the intermediary transfer belt 31 may be independently provided, respectively, and the voltage may be applied to these rollers. In this case, it may be configured that the first and the second fur brushes 81 and 82 are used as the opposite members, and electrically grounded via the first and the second bias rollers 83 and 84. In addition, in this case, it may be configured that to each roller opposite to the first and the second fur brushes 81 and 82, voltages of opposite polarity to the voltages applied to the first and the second bias rollers 83 and 84 in the Embodiments described above are applied. In addition, it may be configured that a voltage is directly applied to the first and the second fur brushes 81 and 82 (or the first and the second fur brushes 81 and 82 are directly electrically grounded).

In addition, in the Embodiments described above, the cleaning device 80 includes two fur brushes of the first fur brush 81 and the second fur brush 82, however, the present invention is not limited to such a configuration. If it is possible to sufficiently remove the transfer residual toner Tr from the intermediary transfer belt 31 with one fur brush, the number of fur brushes may be one. In that case, for example, during image formation, in order to remove the transfer residual toner Tr from the intermediary transfer belt 31, a cleaning bias having negative polarity (-) is applied to the fur brush. And, for example, during image correcting operation, in order to remove the patch pattern Tp from the intermediary transfer belt 31, it is sufficient to switch so as to apply a cleaning bias having positive polarity (+) to the fur brush.

According to the present invention, it becomes possible, while enabling to properly remove the adjustment toner image from the intermediary transfer belt, to achieve a longer life of the intermediary transfer belt and the cleaning member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-009505, filed January 22, 2025, which is hereby incorporated by reference herein in its entirety.

What is claimed is:

1. An image forming apparatus comprising:
a rotatable image bearing member configured to bear a toner image;
an exposing device configured to expose the image bearing member and to form an electrostatic image on the image bearing member;
a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt;
a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating;
a driving portion configured to drive the brush; and
a controller configured to control the driving portion,
wherein the controller controls so as to execute an image forming operation in which the toner image formed on the intermediary transfer belt is transferred to the recording material and an adjusting operation in which an adjustment toner image is formed on the intermediary transfer belt, and
controls the driving portion in the image forming operation so that the brush is rotated at a first peripheral speed Vr when a transfer residual toner remaining on the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and
wherein in a case in which the adjusting operation is executed during a continuous image forming job in which image formation is continuously executed to a plurality of recording materials including a first recording material and a second recording material succeeding the first recording material, after the image formation is executed to the first recording material and before the image formation is executed to the second recording material,
the controller controls the driving portion so as to change the speed of the brush from the first peripheral speed Vr to the second peripheral speed Vp after the first recording material has passed through the second transfer portion and before formation of an electrostatic image of the adjustment toner image is started.

2. An image forming apparatus comprising:
a rotatable image bearing member configured to bear a toner image;
an exposing device configured to expose the image bearing member and to form an electrostatic image on the image bearing member;
a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt ;
a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating;
a driving portion configured to drive the brush; and
a controller configured to control the driving portion,
wherein the controller controls so as to execute an image forming operation in which the toner formed on the intermediary transfer belt is transferred to the recording material and an adjusting operation in which an adjustment toner image is formed on the intermediary transfer belt, and
controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and
wherein in a case in which the adjusting operation is executed during a continuous image forming job in which image formation is continuously executed to a plurality of recording materials including a first recording material and a second recording material succeeding the first recording material, after the image formation is executed to the first recording material and before the image formation is executed to the second recording material,
the controller controls the driving portion so as to change the speed of the brush from the second peripheral speed Vp to the first peripheral speed Vr at a timing after a rearmost portion of the adjustment toner image, formed in the adjusting operation in a moving direction of a surface of the intermediary transfer belt, has reached the cleaning portion and before formation of an electrostatic image for the second recording material is started.

3. An image forming apparatus comprising:
a rotatable image bearing member configured to bear a toner image;
an exposing device configured to expose the image bearing member and to form an electrostatic image on the image bearing member;
a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt ;
a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating;
a driving portion configured to drive the brush; and
a controller configured to control the driving portion,
wherein the controller controls so as to execute an image forming operation in which the toner formed on the intermediary transfer belt is transferred to the recording material and an adjusting operation in which an adjustment toner image is formed on the intermediary transfer belt, and
controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and
wherein in a case in which the adjusting operation is executed with an image formation start signal before the image forming operation is executed to the recording material for a first sheet of a job,
the controller controls the driving portion so as to change the speed of the brush from the first peripheral speed Vr to the second peripheral speed Vp before formation of an electrostatic image of the adjustment toner image is started.

4. An image forming apparatus comprising:
a rotatable image bearing member configured to bear a toner image;
an exposing device configured to expose the image bearing member and to form an electrostatic image on the image bearing member;
a rotatable intermediary transfer belt to which the toner image is transferred from the image bearing member and configured to form a primary transfer portion where the toner image is primarily transferred to the intermediary transfer belt from the image bearing member and a secondary transfer portion where the toner image is secondarily transferred to a recording material from the intermediary transfer belt;
a brush in contact with the intermediary transfer belt at a cleaning portion on a downstream side of the secondary transfer portion and an upstream side of the primary transfer portion with respect to a rotational direction of the intermediary transfer belt, and configured to remove toner from the intermediary transfer belt by electrostatically attracting the toner while rotating;
a driving portion configured to drive the brush; and
a controller configured to control the driving portion,
wherein the controller controls so as to execute an image forming operation in which the toner formed on the intermediary transfer belt is transferred to the recording material and an adjusting operation in which an adjustment toner image is formed on the intermediary transfer belt, and
controls the driving portion in the image forming operation so that the brush is rotated at a first peripheral speed Vr when a transfer residual toner remaining in the intermediary transfer belt is removed from the intermediary transfer belt by the brush, and the brush is rotated at a second peripheral speed Vp faster than the first peripheral speed Vr when the adjustment toner image is removed from the intermediary transfer belt by the brush, and
wherein in a case in which the adjusting operation is executed with an image formation start signal before the image forming operation is executed to the recording material for a first sheet of a job,
the controller controls the driving portion so as to change the speed of the brush from the second peripheral speed Vp to the first peripheral speed Vr after the adjusting operation is executed and before formation of an electrostatic image for the recording material for the first sheet of the job.

5. The image forming apparatus according to claim 1, wherein the brush is a first brush and the cleaning portion is a first cleaning portion,
wherein the image forming apparatus includes
a second brush in contact with the intermediary transfer belt at a second cleaning portion on the downstream side of the secondary transfer portion and the upstream side of the primary transfer portion with respect to the rotational direction of the intermediary transfer belt, and configured to remove the toner from the intermediary transfer belt by electrostatically attracting the toner while rotating,
a first applying portion configured to apply a bias, which moves the toner charged to an opposite polarity to a normal charge polarity of the toner from the intermediary transfer belt to the first brush, to the first cleaning portion, and
a second applying portion configured to apply a bias, which moves the toner charged to the same polarity to the normal charge polarity of the toner from the intermediary transfer belt to the second brush, to the second cleaning portion,
wherein the driving portion drives the first brush and the second brush.

6. The image forming apparatus according to claim 5, wherein the controller controls the driving portion so that the first brush is rotated at a third peripheral speed when the second brush is rotated at the first peripheral speed Vr and the first brush is rotated at a fourth peripheral speed faster than the third peripheral speed when the second brush is rotated at the second peripheral speed Vp.
